(19) United States
(12) Patent Application Publication
(10) Pub. No.: US 2009/0182563 A1
(43) Pub. Date: Jul. 16, 2009

(54) SYSTEM AND A METHOD OF PROCESSING AUDIO DATA, A PROGRAM ELEMENT AND A COMPUTER-READABLE MEDIUM

(75) Inventors: Daniel Willem E. Schobben, Waalre (NL); Steven Leonardus J.D. Van De Par, Tilburg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,510

(22) PCT Filed: Sep. 15, 2005
(86) PCT No.: PCT/IB05/53031

§ 371 Date: Mar. 19, 2007

(30) Foreign Application Priority Data
Sep. 23, 2004 (EP) 04104624.4

(51) Int. Cl. G10L 21/00

(52) U.S. Cl. 704/500; 704/E19.001

(57) ABSTRACT

A system (100) of processing audio data, comprising a decoding unit (102) and a determining unit (102, 106) having first determining means (102) and second determining means (106). The decoding unit (102) is adapted to decode encoded audio data to generate decoded audio data. The first determining means (102) is adapted to determine properties of the decoded audio data and/or of reproduction conditions under which the decoded audio data is to be reproduced, and the second determining means (106) is adapted to determine an amount of reverberation and/or of cross-talk to be added to the decoded audio data based on the determined properties of the decoded audio data and/or of the determined reproduction conditions under which the decoded audio data is to be reproduced.

### FIELD OF THE INVENTION

The invention relates to a system of processing audio data.

The invention further relates to a method of processing audio data.

Moreover, the invention relates to a program element.

Further, the invention relates to a computer-readable medium.

### BACKGROUND OF THE INVENTION

Audio compression and audio signal data processing become more and more important, since there is a huge market for devices capable of reproducing compressed audio data related to music, audio books, or the like.

MP3, or more precisely “MPEG-1 Audio Layer 3” is an audio compression algorithm capable of greatly reducing the amount of memory required to store audio and the amount of data needed to reproduce audio, while sounding like a faithful reproduction of the original uncompressed audio to a listener. The MP3 format uses a hybrid transform to transform a time domain signal into a frequency domain signal. MP3 is a lossy compression scheme, meaning that it removes information from the input in order to save space. Thus, MP3 algorithms work hard to ensure that human listeners cannot detect the sounds it removes, by modelling characteristics of human hearing such as noise masking. Consequently, huge savings in storage space can be achieved with acceptably small losses in fidelity.

However, in the field of audio compression, it may be necessary to process a decompressed audio signal to improve the subjective quality of the reproduced audio signals, as sensed by a user.

According to WO 2004/006625, an amount of stereo base widening is adapted to the quality of decoded audio.

U.S. Pat. No. 6,763,275 B2 discloses a method for processing and reproducing audio signals, wherein audio reproduction control information indicating the adjustment of a sound quality is added to digital audio signals. Thus, the digital audio signal is recorded with pieces of audio reproduction control information. When a user selects a piece of audio reproduction control information, audio data of the digital audio signal are adjusted according to the audio reproduction control information, so that the user can hear the music at a desired sound quality.

The acceptance of encoders/decoders (codecs) for encoding and decoding audio signals according to the prior art working at very low bit-rates (e.g. 64 kb/s for stereo content) is low, since they produce audible artefacts for certain content, particularly when evaluated using headphones. In other words, audio signals processed by encoders/decoders and in particular compressed audio data frequently suffer from poor quality.

Thus, the systems of processing audio data according to the prior art have the disadvantage that, particularly under critical circumstances, the quality of decoded audio data is not sufficient.

### OBJECT AND SUMMARY OF THE INVENTION

It is an object of the invention to improve the subjective quality of decoded audio data with few effort.

In order to achieve the object defined above, a system of processing audio data, a method of processing audio data, a program element and a computer-readable medium according to the independent claims are provided.

The system of processing audio data of the invention comprises a decoding unit adapted to decode encoded audio data to generate decoded audio data; first determining means adapted to determine properties of the decoded audio data and/or of reproduction conditions under which the decoded audio data is to be reproduced; second determining means adapted to determine on the one hand an amount of reverberation and/or of cross-talk to be added to the decoded audio data based on the determined properties of the decoded audio data and/or on the other hand the determined reproduction conditions under which the decoded audio data is to be reproduced.

Moreover, the invention provides a method of processing audio data, wherein the method comprises the steps of decoding encoded audio data to generate decoded audio data; determining properties of the decoded audio data and/or of reproduction conditions under which the decoded audio data is to be reproduced, and determining on the one hand an amount of reverberation and/or of cross-talk to be added to the decoded audio data based on the determined properties of the decoded audio data and/or on the other hand of the determined reproduction conditions under which the decoded audio data is to be reproduced.

Furthermore, a program element is provided by the invention, which, when being executed by a processor, is adapted to carry out a method of processing audio data comprising the steps according to the above-mentioned method of processing audio data.

Beyond this, a computer-readable medium is provided, in which a computer program is stored which, when being executed by a processor, is adapted to carry out a method of processing audio data comprising the steps according to the above-mentioned method of processing audio data.

The characteristic features according to the invention particularly have the advantage that the quality of decoded audio data can be significantly improved by adding an amount of reverberation and/or of cross-talk to the audio data, wherein the added amount of reverberation and/or of cross-talk is determined based on an analysis of the decoded audio data and/or of conditions of the environment in which reproduced audio data are to be emitted. It has been found by the inventors that such an added reverberation and/or cross-talk contribution significantly improves the subjective quality of reproduced compressed audio data, i.e. the subjective impression of a human listener of the quality of the audio reproduction. Thus, under circumstances in which the quality of decoded audio data is not sufficient for a human listener (e.g. because of a relatively poor objective quality of the audio signal data), the subjective quality is improved by manipulating at least a part of the audio data by superimposing a reverberation component or a cross-talk component or reverberation and cross-talk components. However, in a scenario in which an analysis of the decoded audio data gives the result that the quality is already sufficient without adding reverberation and/or cross-talk components, no such contribution will be added to the decoded audio data. In other words, depending on the result of the analysis of the audio data and of the acoustic environment, it will be determined which amount of reverberation/cross-talk should be added, or alternatively that no reverberation/cross-talk should be added (i.e. the added amount equals to zero in the latter case).

Thus, a flexible system of manipulating—if desired—a decoded audio signal is provided by the invention. The system allows storing audio data with few memory efforts, to process audio data very quickly, and to achieve simultaneously a sufficiently high subjective quality of reproduced audio.

As will be described in detail below, research by the inventors has shown that adding reverberation to decoded audio that may have been heavily compressed helps to eliminate audible artefacts for headphone playback. Particularly at relatively low bit-rates, for example 64 kb/s or 80 kb/s, a significant improvement is obtained by adding reverberation. The amount of reverberation that is required to securely hide artefacts depends heavily on the quality (for example bit-rate) as well as on the nature of the audio signal. The kind or nature of the audio signal (for example classical music, pop music, jazz music, castanets or the like) has a strong influence on the subjective quality sensed by a listener. When audio signals of different nature are compressed, it may happen that only some of the music elements need to be manipulated by adding reverberation and/or cross-talk to improve the quality, whereas other parts have a sufficient subjective quality without being manipulated. According to the invention, properties like the quality/bit-rate as well as the nature/repertoire of the audio signals are taken into account to dynamically adjust a reverberator unit and/or a cross-talk unit so as to introduce just enough reverberation and/or cross-talk as is required. However, high quality tracks can be left alone.

Thus, the invention teaches a system comprising an audio decoder for decoding compressed audio data and reverberator means, wherein the output of the audio decoder is reverberated and the amplitude and/or decay time of the reverberator means may be controlled by a quality parameter of the compressed audio. Additionally, cross-talk may be added to the decoded audio signal as well.

In other words, encoded (e.g. compressed) audio data is input in an audio decoder (e.g. an MP3 decoder) and is decoded (e.g. decompressed). The quality of the audio signals (e.g. indicated by a bit-rate) parameter is analyzed, and this analysis controls a reverberator that, if necessary to achieve a predetermined subjective audio quality threshold, adds a reverberation contribution and/or a cross-talk contribution to the decoded data.

Thus, audible artefacts are eliminated particularly in the case of headphone playback of decoded audio that has been heavily compressed.

An important aspect of the invention can be seen in the idea to add reverb to headphone signals depending on the quality of MP3 data.

Natural reverberation is created when sound is produced in an enclosed space and multiple reflections build up and blend together to create reverberations or reverb.

However, according to the invention, reverberation is created artificially, i.e. particularly electronic mechanisms are used to create a reverberation effect. So-called DSP (“digital signal processing”) reverberators use electronics and signal processing algorithms to create the effect of reverberation through the use of large numbers of long delays with quasi-random lengths, which may be combined with equalization, envelope-shaping and other processes. A DSP reverberator may also use convolution and a pre-recorded impulse response to simulate an existing real-life space. By adding reverberation to an audio signal, an auditor has the subjective impression that a reverberated signal has been recorded in a reverberating environment, and not in a “dry” studio.

The term “cross-talk” as used in this description means that sound from a left audio reproduction apparatus (e.g. a left loudspeaker) also arrives at a right ear, and vice versa. According to the invention, cross-talk can be artificially added to a decoded audio signal which in many cases yields an improved subjective impression of a listener concerning the quality of the audio data.

The term “audio data”, in the meaning of the invention, includes any signal that at least partially contains audio data. However, additional data may be included in a data package being transmitted. For example, video data containing audio information and visual information are included in the invention as well. In this case, the method of the invention is only applied to the audio part of the transmitted signals.

Listening tests have shown that adding reverberation and/or cross-talk improves the quality of emitted audio signals perceived by a human listener. Thus, heavy data compression methods like MP3 can be advantageously combined with the teaching of the invention, since a loss in the objective audio quality due to a lossy compression algorithm can be compensated by artificially adding reverb/cross-talk, consequently improving the subjective quality of the audio signals felt by a user. Such listening experiments have shown that headphone listening is more critical than loudspeaker listening, concerning the subjective quality of the audio signals. Therefore, according to the invention, by adding reverberation and/or cross-talk, a situation similar to a situation of loudspeaker listening can be achieved as well in the case of headphone listening.

The system of the invention automatically adds reverberation and/or cross-talk contributions to audio data, based on quality parameters like the bit-rate. It is estimated which kind of audio signal portions with which kind of quality are present and which environment conditions are present. Based on the determination of this information, the amount of reverberation/cross-talk to be added may be selected for each audio signal portion separately.

A computer program can realize the processing of audio data according to the invention i.e. by software, or by using one or more special electronic optimization circuits, i.e. in hardware, or in hybrid form, i.e. by means of software components and hardware components.

Referring to the dependent claims, further preferred embodiments of the invention will be described in the following.

Next, preferred embodiments of the system of processing audio data will be described. These embodiments may also be applied for the method of processing audio data, the program element and the computer-readable medium.

In the system of the invention, the decoding unit may comprise a decompression unit adapted to decompress compressed audio data to generate decoded audio data. Particularly in a scenario in which decoding encoded audio data means decompressing compressed audio data, quality problems may occur when reproducing the decompressed data, particularly in the case of a lossy compression scheme, like MP3. Such a objective quality loss can be compensated concerning the relative impression of a human listener by adding a reverberation and/or cross-talk contribution to the decoded audio data.

The decompression unit may be particularly adapted to decompress compressed audio data having an MP3 format (MPEG-1 Audio Layer 3). By combining an MP3 compression algorithm capable of greatly reducing the amount of data required to reproduce audio with the adding of reverberation and/or cross-talk, a high compression ratio is achieved with a sufficient high subjective quality of decompressed data.

The first determining means of the system may be adapted such that the properties of the decoded audio data, based on which an amount of reverberation and/or of cross-talk to be added to the decoded audio data is determined, include a quality parameter indicating the quality of the decoded audio data. In other words, by evaluating the (objective) quality of the decoded audio data, a reliable criterion is evaluated, based on this it can be decided whether it is necessary to add reverberation and/or cross-talk to improve the subjective quality perceived by an average human listener. If the determined quality is already sufficient without any manipulation, an amount of zero of reverberation and of cross-talk is added, i.e. no manipulation of the decoded audio signal is performed. However, if the quality is less than a predetermined minimum quality threshold value, then the difference between the present quality value and a predetermined minimum quality threshold value may be used as a measure to determine which amount of reverberation and/or cross-talk needs to be added to achieve sufficient quality.

The quality parameter may be the bit-rate of the audio data. The bit-rate indicates the transmitted bits per time unit, i.e. indicates the number of stored bits per second of an audio signal. The bit-rate indicates the quantity of stored bits per second of the audio signal. Thus, the bit-rate is a suitable parameter for determining whether an audio signal should be manipulated by adding reverberation and/or cross-talk, or not.

Additionally or alternatively, the quality parameter may be derived from the amount and/or the distribution of spectral holes of the audio data. For a constant bit-rate encoding, MP3 dynamically reduces the bandwidth of the encoded audio so as to maintain a high quality for lower frequencies. When possible, the encoder switches back to full bandwidth. Continuously switching to a band-limited spectrum and back causes spectral holes. Thus, the number of spectral holes, as indicated by a codebook parameter in the bit stream, can be used to determine if a signal manipulation is necessary. If said number of spectral holes is too large, this may be considered to be an indication of poor perceptual quality. This can be used a trigger that reverb and/or cross-talk shall be switched on. Taking into account the amount and/or the distribution of spectral holes is an important aspect, since frequent switching between spectral hole and no spectral hole in a particular band is often more annoying than a continuous spectral hole.

The first determining means may be adapted such that the properties of the decoded audio data, based on which an amount of reverberation and/or of cross-talk to be added to the decoded audio data is determined, includes the nature of the decoded audio data. For example, different types of music tend to sound best with different amounts of reverberation. Thus, the kind/nature/genre of audio signals to be recorded/reproduced is preferably included in the decision which amount of reverberation and/or cross-talk should be added. Automatic audio classifiers that automatically tell jazz apart from pop music, rock and other genres are well known in the art.

The first determining means of the system may be adapted such that the properties of the decoded audio data, based on which an amount of reverberation and/or of cross-talk to be added to the decoded audio data is determined, includes the fact whether a mid-side coding is used for encoding audio data. Thus, a quality parameter for judging the amount of reverberation and/or cross-talk to be added may be derived from the bit-rate in conjunction with a fixed parameter in the MP3, namely the mid-side coding (Y/N). The presence or absence of mid-side coding can be taken as a measure whether the addition of reverberation and/or cross-talk is necessary or not. Mid-side coding is a feature related to the MP3 technology according to which, instead of transmitting a left channel L and a right channel R, a mid-channel M=(L+R)/2 and a side-channel S=(L−R)/2 is transmitted. By taking this measure, a further compression is achieved particularly in the case of mono-like signal portions.

Mid-side coding is one of the settings of an MP3 encoder. Others include the audio bandwidth which need not be directly related to half the sample frequency. Also, variable bit-rate of constant bit-rate may be selected.

Thus, the first determining means may be adapted such that the properties of the decoded audio data, based on which an amount of reverberation and/or of cross-talk to be added to the decoded audio data is determined, include an audio bandwidth of the decoded audio data. The audio bandwidth need not be directly related to half the sample frequency.

Moreover, the first determining means may be adapted such that the properties of the decoded audio data, based on which an amount of reverberation and/or of cross-talk to be added to the decoded audio data is determined, include the fact whether a variable bit-rate is present in the decoded audio data. For the audio data, a variable bit-rate or constant bit-rate may be selected.

Further, the first determining means of the system may be adapted such that the properties of the decoded audio data, based on which an amount of reverberation and/or of cross-talk to be added to the decoded audio data is determined, includes a time-varying bit stream parameter of the decoded audio data.

By introducing the time dependence of the bit stream parameters as a determination criterion whether the introduction of reverberation and/or cross-talk is reasonable, the quality of the generated audio signal may be improved.

The first determining means may further be adapted such that the reproduction conditions under which the decoded audio data is to be reproduced, based on which an amount of reverberation and/or of cross-talk to be added to the decoded audio data is determined, includes the type of reproduction apparatus by which a decoded audio data is to be reproduced. This embodiment is based on the cognition of the inventors that headphone listening is more critical than loudspeaker listening. In other words, there is a strong impact of using loudspeakers versus headphone playback on the subjective quality of compressed audio. Thus, in the case in which the decoded audio data is emitted using a loudspeaker, it is frequently not necessary to add reverberation and/or cross-talk to achieve a sufficient quality. However, since headphone playback is more critical, in this case it is more often advantageous to add reverberation and/or cross-talk to the audio data before transmitting the data to the headphones as reproduction apparatus. Thus, by taking into account the kind of reproduction apparatus used, the reliability of the estimation of the amount of reverberation and/or cross-talk to be added to the audio signal is further improved.

Particularly, the first determining means may be adapted such that the reproduction conditions under which the decoded audio data is to be reproduced, based on which an amount of reverberation and/or of cross-talk to be added to the decoded audio data is determined, may include the fact whether the decoded audio data is to be reproduced by a loudspeaker or by a headphone.

For instance, a switch may detect the presence of a headphone, similar to the way a headphone may be detected in today HIFI systems to auto-mute the speakers. Alternatively, a compact MP3 player can judge from the impedance it recognizes at the headphone output whether headphones are connected or the player is connected to another device.

Beyond this, the first determining means may be adapted such that the reproduction conditions under which the decoded audio data is to be reproduced, based on which an amount of reverberation and/or of cross-talk to be added to the decoded audio data is determined, may include the amount of natural reverberation of an environment in which the decoded audio data is to be reproduced. In other words, the decision if the addition of reverberation and/or cross-talk is necessary may be taken by considering measured data of acoustical properties or the environment, in which the audio signals are to be emitted. For instance, in a dry environment in which almost no natural reverberation occurs, it might be advantageous to add artificial reverberation to the audio signal to improve the subjective quality of the audio data. On the other hand, if sufficient natural reverberation is already present due to the physical properties of the environment, it might be dispensable to add reverberation. Thus, also in case where loudspeakers are used as a reproduction apparatus, reverberation and/or cross-talk may be added.

For instance, a microphone might be integrated in a receiver (radio/amplifier) to detect the reverberation of an environment (e.g. a room) in response to sounds played over the loudspeaker.

The first determining means may be adapted to determine an amplitude and/or a decay time of reverberation to be added to the decoded audio data. The separate adjustment of the different parameters of amplitude and decay time of reverberation allows a further refinement of the adjustment of the reverberation properties to improve the subjective quality of emitted audio data.

Further, the system of the invention may comprise an adding unit adapted to add the amount of reverberation and/or of cross-talk determined by the second determining means to the decoded audio data to generate output audio data. Thus, an adding unit coupled to the decoding unit adds the necessary amount of reverberation and/or of cross-talk to optimize the transmitted audio signal quality.

Moreover, headphones may be included in the system of the invention, wherein a headphone may be connected to the adding unit being adapted to generate and emit acoustic waves based on the output audio data. Thus, also under critical conditions, which are frequently present in the case of headphones, a sufficient subjective quality of the audio signals can be achieved by adding reverb and/or cross-talk.

The system of the invention may be realized as an integrated circuit, particularly as a semiconductor integrated circuit. In particular, the system can be realized as a monolithic IC which may be fabricated in silicon technology.

The system of the invention may be realized as a portable audio player, as an internet radio device, as a DVD player (preferably with MP3 playback facility), as an MP3 player or and so on.

In the following, an embodiment of the method of processing audio data will be described. However, this embodiment also applies to the system of processing audio data, to the program element and to the computer-readable medium.

According to the method of the invention, the amount of reverberation and/or of cross-talk to be added to the decoded audio data may be determined dynamically. The term “dynamically” means that the audio data may be divided into a plurality of sub-portions, wherein each sub-portion may be analyzed individually concerning the decision to which extent reverberation and/or cross-talk should be added. Thus, a time dependent determination of the necessary amount of reverberation and/or cross-talk is possible, so that the flexibility and quality is significantly improved when compared to a static system in which a constant amount of reverberation and/or cross-talk is added regardless the properties of a particular sub-portion. However, also such a static solution falls under the scope of this invention and allows an improvement with very low computing power.

The aspects defined above and further aspects of the invention are apparent for the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows a schematic view of a system of processing audio data according to a first embodiment of the invention.

FIG. 2 shows a schematic view of a system of processing audio data according to a second embodiment of the invention.

FIG. 3 shows a schematic view illustrating a mix of signals for adding reverberation and cross-talk in conjunction.

FIG. 4 shows a matrix illustrating listening test sessions in which unfiltered excerpts are presented as well as a version with reverberation, cross-talk and both reverberation and cross-talk.

FIGS. 5A to 5C show diagrams illustrating the impact of reverberation to the subjective quality of audio data.

FIGS. 6A to 6C show diagrams illustrating the impact of cross-talk to the subjective quality of audio data.

FIGS. 7A to 7C show diagrams illustrating the impact of reverberation and cross-talk in combination to the subjective quality of audio signals.

### DESCRIPTION OF EMBODIMENTS

The illustration in the drawings is schematic.

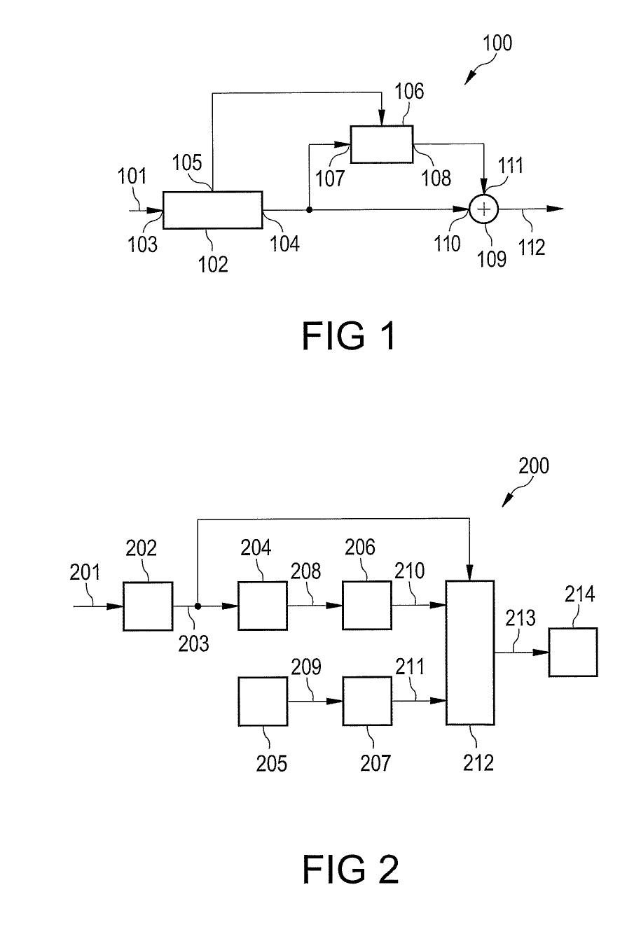

In the following, referring to FIG. 1, a system 100 of processing audio data according to a first embodiment of the invention will be described in detail.

The system of processing audio data 100 comprises a decoding unit in form of an audio decoder 102 (e.g. an MP3 decoder) and a reverberator unit 106 and an adding unit 109.

The audio decoder 102 is adapted to decode compressed audio data 101 provided at a compressed audio data input 103 of the audio decoder 102 to generate decoded and decompressed audio data provided at a decompressed audio data output 104. Further, the audio decoder 102 has a quality parameter output 105 at which a quality parameter (e.g. the bit-rate) indicating the quality of the processed audio data is provided. By means of the audio decoder 102 and the quality parameter output 105 first determining means are provided, which first determining means are adapted to determine properties of the decoded audio data and/or of reproduction conditions under which the decoded audio data is to be reproduced.

Based on the quality parameter provided to the reverberator unit 106, the reverberator unit 106 determines an amount of reverberation to be added to the decompressed audio data. Thus, the reverberator unit 106 constitutes second determining means and estimates which amount of reverberation should be added to the decompressed audio data to achieve a sufficient quality impression for a user listening to the output data. By adding reverberation, the subjective quality of decompressed audio data having a non-sufficient objective quality can be improved. The reverberator unit 106 determines the amount of reverberation to be added to the audio data on the basis of the quality parameter and on the basis of the decompressed audio data provided at a reverberator input 107. A first adding input 110 of the adding unit 109 is provided with the decompressed audio data provided at the decompressed audio data output 104 of the audio decoder 102. An adding signal including the amount of reverberation to be added to the decompressed audio data is provided at a reverberator output 108, which reverberator output 108 is connected with a second adding input unit 111 of the adding unit 109. In other words, the signals provided at the first adding unit input 110 and at the second adding unit input 111 are added to form a manipulated audio data output 112 having components of the decompressed audio data and of the added reverberation.

As can be seen from FIG. 1, the decompressed audio data decoded by the audio decoder 102 is reverberated and the amplitude and/or decay time of the reverberator 106 are controlled by the quality parameter, namely the bit-rate. Thus, FIG. 1 shows an embodiment in which the amplitude and the decay rate of the reverberator 106 depends on the bit-rate of the MP3.

Alternatively to the described embodiment of FIG. 1, in which the quality parameter is derived directly from the bit-rate, other fixed parameters in the MP3 may be used additionally or alternatively to the bit-rate, such as mid-side coding (Y/N).

According to another embodiment of the present invention, the quality parameter may be estimated by also analyzing the time-varying bit stream parameters and/or the decoded signal. As an example, when the number of spectral holes as indicated by the codebook parameters in the bit stream is too large, this may be considered to be an indication of poor perceptual quality and reverb may be switched on.

In the following, referring to FIG. 2, an audio data processing device 200 according to a second embodiment of the invention will be described.

As can be seen from FIG. 2, encoded data 201 is provided at an input of MP3 decoder 202 that decodes the encoded data 201 to provide decoded audio data 203. The decoded audio data 203 are provided to an audio data analyzing unit 204 for estimating an audio data property parameter 208, namely the bit-rate of the audio data. This audio data property parameter 208 is provided to a first determining sub-unit 206 for determining a first reverberation contribution based on the bit-rate of the audio data. Thus, a first reverberation contribution signal 210 is generated which is provided to an adding unit 212.

Simultaneously, an environmental condition analyzing unit 205 analyzes an environmental condition, i.e. the physical properties of the environment in which the audio data shall be emitted. For example, it may be detected that an environment does not provide sufficient natural reverberation, by emitting an audio test signal and by detecting a response signal in response to the test signal to evaluate the natural reverberation properties of the environment. An environmental condition parameter 209, reflecting said environmental reverberation properties, is provided to a second determining sub-unit 207, which second determining sub-unit 207 determines a second reverberation contribution signal 211. In other words, said reverberation contribution signal 211 is representative for determined reproduction conditions under which the decoded audio data 203 is to be reproduced. This signal 211 is also provided to the adding unit 212. Thus, the adding unit 212 can add to the decoded audio data 203 (which is provided to the adding unit 212 by the MP3 decoder 202) an amount of reverberation based on the audio data information provided by the audio data analyzing unit 204 and based on environmental conditions provided by the environmental condition analyzing unit 205. At the output of the adding unit 212, a reverberation containing decoded audio data 213 is provided which is supplied to a sound reproduction means (e.g. a headphone) 214 for emitting the audio data to the environment.

In the following, the effect of room acoustics on MP3 audio quality evaluation—on which the invention is based—will be described.

The impact of using loudspeaker versus headphone playback on the subjective quality of compressed audio is significant. It will be shown in the following that reverberation and cross-talk, which both may be introduced naturally in loudspeaker playback, can effectively hide coding artefacts. In double blind listening tests, subjects rated MP3 coded excerpts at various bit-rates. The excerpts were played back over headphones. Reverberation and cross-talk can be introduced artificially to simulate loudspeaker playback, so that their impact can be assessed separately. Experimental results show that quality scores of the reverberated excerpts are significantly higher than for the corresponding ‘dry’ excerpts for 64 kb/s bit-rate. These differences are particularly pronounced at lower bit-rates. This indicates that coding artefacts can become less audible in reverberant listening conditions.

An audio encoder and decoder (codec) can both be evaluated based on listening tests with loudspeaker and/or headphone playback. Often, the audibility of coding artefacts depends heavily on the playback conditions. Here, the origin of these differences is discussed by introducing characteristics of room acoustics step by step into a headphone playback system. Both cross-talk and reverberation may be introduced separately or jointly.

Headphone listening is more critical than loudspeaker listing. This is consistent over various excerpts, bit-rates and subjects. Unlike headphone sound reproduction, loudspeaker sound reproduction introduces cross-talk, i.e. sound from the left loudspeaker also arrives at the right ear and visa versa. In addition, early reflections and reverberation are introduced. Cross-talk has the potential to mask strong coding errors for one channel by adding a significant contribution of the other channel. Reverberation is only very weakly correlated across channels except for low frequencies. It strongly affects the spatial attributes of the audio. In addition, reverberation has the tendency to distribute the energy of the audio signal across time. The effect of reverberation and cross-talk separately and in conjunction will be discussed in the following as well.

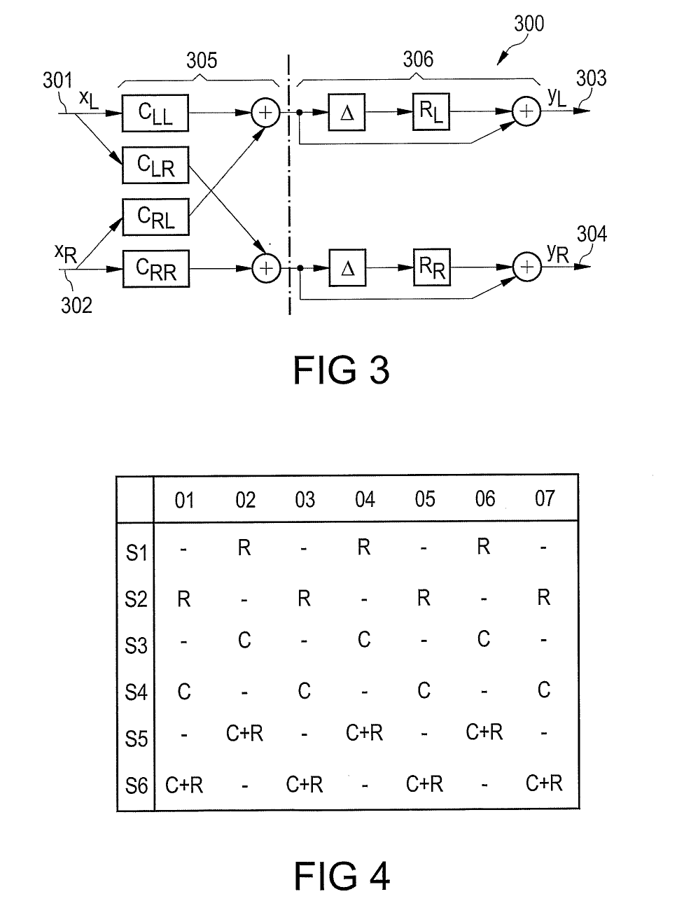

Loudspeaker playback can be simulated. Introducing reverberation on headphones can be done artificially without introducing cross-talk, e.g. to investigate its impact on the audibility of coding artefacts. This does not correspond to any standard listening room, as it would require that both ears of the subject reside in separate rooms each containing one loudspeaker. Cross-talk can also be introduced on headphones without introducing reverberation or early reflections. This corresponds to listening in an anechoic chamber, which again is quite unlike a standard listening room. The advantage of headphone playback is that both reverberation and cross-talk can easily be introduced separately and in conjunction, were the latter is arranged to be a cascade of the separate systems as is shown in FIG. 3.

In the following, referring to FIG. 3, a schematic diagram 300 will be explained in which a scheme for introducing reverberation and cross-talk, is illustrated.

A first audio signal x_{L} (“left”) is provided at a first input 301, and a second audio signal x_{R} (“right”) is provided at a second input 302. A cross-talk introduction stage 305 introduces cross-talk in the signals provided at the first input 301 and at the second input 302. A reverberation introduction stage, 306 introduces reverberation in the signals provided at the first input 301 and at the second input 302. Thus, the signal y_{L} (“left”) provided at a first output 303 and the signal y_{R} (“right”) provided at a second output 304 have added contributions of cross-talk and of reverberation. Thus, FIG. 3 shows post processing applied to decoded MP3 content x_{L}, x_{R}.

The cross-talk system 305 and the reverberation system 306 may be implemented individually as well. In the cascaded system of FIG. 3, only two reverberation filters RL, RR are used rather than one per every cross-talk filter C_{LL}, C_{LR}, C_{RL}, C_{RR}. This is a good approximation, see WO2002/098172. Another consequence of cascading the two systems is that the reverberation filters are convolved with the cross-talk filters rather than using them in parallel. This slightly affects the spectrum of the reverberated sounds. Temporal aspects are not assumed to change much though, as the cross-talk filters are strongly focused in time. On the other hand, the two systems 305, 306 can be joined without modifications, allowing for a good comparison of the separate and the joint systems.

Introducing the reverberation after the cross-talk also maintains the desirable property that the reverberation to the left and right ears are statistically independent as described next. The MP3 encoding/decoding is done prior to the addition of reverberation and cross-talk. All audio tracks, including the original, are preferably scaled to prevent clipping.

Cross-talk may be introduced to simulate the loudspeaker reproduction. For signal x_{L}, two basic auditory cues are introduced associated with reproduction on the left loudspeaker; the Interaural-Time-Delay (ITD) and the Interaural-Intensity Difference (IID). The IID and ITD indicate the differences between the signals arriving at the right and left ear of the listener. They may be derived from a spherical head model using Woodworths' model (see C. P. Brown and R. O. Duda, “A Structural Model for Binaural Sound Synthesis”, IEEE Transactions on Speech and Audio Processing, Vol. 6, No. 5, September 1998) and can be implemented in Matlab (see MathWorks Inc. Company Info, http://www.mathworks.com/company/). The spherical head model is generally well known and it can therefore easily be reproduced. Head-Related-Transfer-Functions (HRTFs) measured from a human head contain more auditory cues than just the ITD and IID and are known to provide superior accuracy in critical localization tasks. The implementation of choice is not expected to influence the results to a large extend, as it deals with the concealment of coding artefacts rather than exact localization. The ITD expressed in seconds is computed from equation (1):

$$ITD = \frac{a}{c} ( \frac{πα}{180} + sin ( \frac{πα}{180} ) ) \qquad ( 1 )$$

with a denoting a radius of a human head of 0.0875 m, c is the speed of sound in air of 343 m/s and α is the loudspeaker angle of 30 degrees. This corresponds to a standard stereo loudspeaker setup with an opening angle of 60 degrees. The ILD is implemented as a single pole, single zero filter giving a slight boost to the ipsi-lateral ear and an attenuation to the contra-lateral ear for frequencies above 1 kHz.

The right loudspeaker may be simulated in a similar way as the left one, choosing an angle α of −30 degrees. By the addition of all these signals, as indicated in FIG. 3, approximately the same signals are presented through headphones as would be present for stereo loudspeaker reproduction.

The reverberation may be artificially generated so as to have full control over its parameters. The reverberation can be applied to the excerpts by convolving the left and right ear audio signals with R_{L} and R_{R}, which consist of independent white noise sequences with an exponentially damped envelope (see Martin, D. Van Maercke, and J-P. Vian, “Binaural simulation of concert halls: A new approach for the binaural reverberation process”, J. Acoust. Soc. Am., vol. 94, no. 6, pp. 3255-3264, December 1993). This approach is favourable for the sake of reproducibility. Statistically independent noise sequences are quite accurate models of reverberation except for low frequencies for which the wavelength is larger than the radius of the human head. This method is sufficiently accurate for the purpose of the invention, which does not primarily focus on aspects such as localization and naturalness. The decaying noise tail models both the early reflections and the late reverberation. A delay Δ of 3.4 ms may be inserted in cascade with the decaying noise tail, to account for the difference in arrival time between the direct path and the early reflections. The direct-to-reverberant ratio can be 2.1 dB, simulating the situation that the listener is just inside the reverberation radius, which is not uncommon in home environments. A reverberation time of 0.22 seconds may be used throughout, which is quite typical in living rooms (see M. A. Burgess and W. A. Utley, “Reverberation times in British living rooms”, Applied Acoustics, vol. 18, pp. 369-380, 1985.).

In the following a listening test design will be described which may be used for investigating the effect which reverberation and cross-talk have on the perceived quality of MP3 audio. Subjects were asked to give quality ratings to seven stereo excerpts that were encoded with an MPEG 1 layer 3 encoder. The excerpts are listed in Table 1. In a MUSHRA listening test (see ITU-R Recommendation BS. 1534, “Method for the subjective assessment of intermediate quality level of coding systems”, June 2001), subjects had to rate the audio quality for excerpts encoded at 64, 80, and 128 kb/s bit-rates. For the MP3 encoding a Fraunhofer encoder was used (see MPEG Layer-3 audio compression technology by Fraunhofer IIS and Thomson multimedia, plug-in for cool-edit, 1999 Syntrillium Software Corporation.). The bandwidth was set to 22050 Hz, the sample rate was 44100 Hz. The codec was set to constant bit-rate and the setting “Fast Codec (High Quality)” was chosen.

When investigating the effect of reverberation, a direct comparison of an MP3 file and a reverberated version of it may create a number of audible effects. On the one hand, artefacts may be made less prominent due to the reverberation. On the other hand the reverberation itself or the spatial sensation it provides may affect the ratings. To avoid this latter effect, for each rating condition in the MUSHRA test subjects had to compare original and MP3 encoded excerpts that were all filtered in the same way, i.e. by reverberation and/or cross-talk.

TABLE 1
Listening test excerpts

| Excerpt | Description |
|---|---|
| O1 | Plucked strings |
| O2 | Castanets |
| O3 | Harpsichord |
| O4 | Suzanne Vega |
| O5 | Spanish orchestra playing Spanish music |
| O6 | Jazzy wind instruments and percussion |
| O7 | Jazz Song |

The listening tests were divided in six sessions S1-S6 as is shown in FIG. 4. Each session consisted of seven sub-experiments, each covering one excerpt O1-O7. In each session filtered (reverberation ‘R’, cross talk ‘C’, combination ‘C+R’) and unfiltered (‘-’) items were presented in a nearly balanced way across sessions. If all unfiltered items would have been presented in session S1 and all reverberated items would have been presented in session S2, a response bias might occur, e.g. because listeners tend to use the whole rating scale independent of the average quality of the items. When the items are presented as indicated in FIG. 4, filtered and unfiltered items are distributed across two sessions, avoiding the effects of response bias. For example reverberated and unfiltered items are distributed across sessions S1 and S2.

Each entry in FIG. 4 represents one rating condition in the MUSHRA test. For each such condition six different versions of the excerpt were presented; three versions encoded at the mentioned bit-rates, two low-pass filtered anchor versions (3.5 kHz and 7 kHz cut-off frequency) and a hidden reference, which was identical to the uncompressed excerpt. For an entry indicated with ‘R’, the six versions including the uncompressed excerpt are processed with the reverberation algorithm.

Subjects were not informed about what version was played at any time, except that they were able to listen to the uncompressed excerpt on demand. Quality ratings had to be given on a 100 points scale for the six different versions of the excerpt while the subjects could freely switch. This process was repeated for all entries in FIG. 4. Thus, FIG. 4 shows listening test sessions S1-S6 in which the unfiltered (‘-’) excerpts are presented as well as versions with reverberation (‘R’), cross-talk (‘C’) and both reverberation and cross-talk (‘C+R’).

In all sessions, 15 subjects participated, aged 20-29. None of the subjects had known hearing problems. Philips SBC HP 1000 headphones were used for presenting the excerpts to the subjects, which are circum-aural type headphones with a reasonably flat frequency response. No equalization was applied.

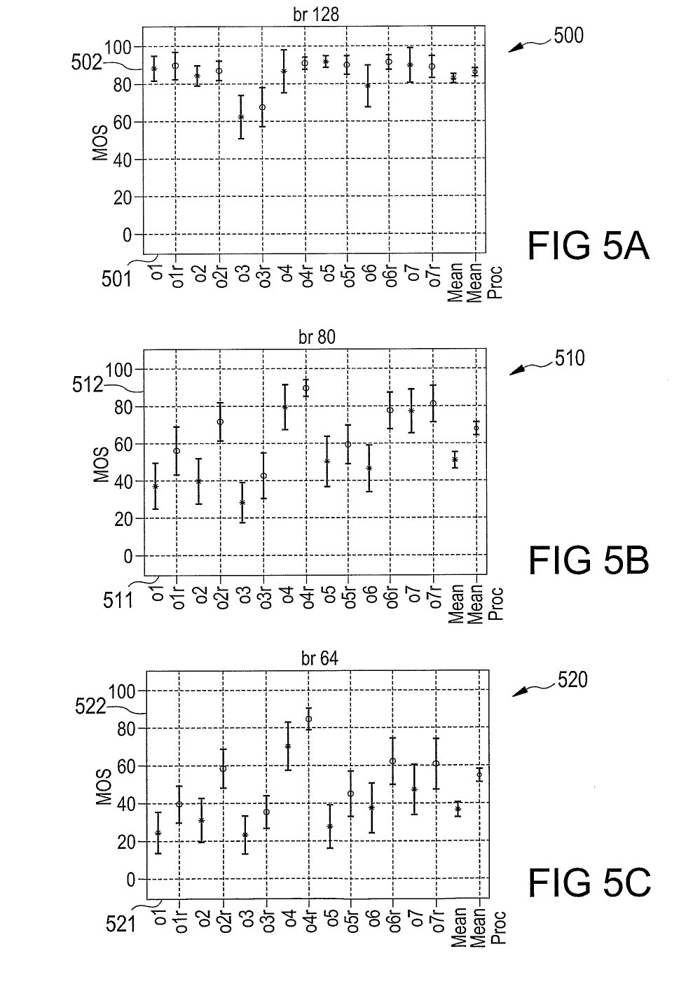

In the following, the listening test results will be described. The listening tests responses are analyzed and presented as Mean Opinion Scores (MOS) in FIG. 5A to FIG. 7C on a 100 points scale ranging from poor (0) to excellent (100).

FIG. 5A to FIG. 5C show, for a bit-rate of 128 kb/s (FIG. 5A), of 80 kb/s (FIG. 5B), and of 64 kb/s (FIG. 5C), diagrams 500, 510, 520 having abscissa 501, 511, 521 along which experiments with different excerpts O1-O7 are plotted, with (Oir) and without (Oi) reverberation included, wherein i=1, 2, . . . , 7. Along ordinates 502, 512, 522, the Mean Opinion Scores (MOS) are plotted for the different experiments, respectively.

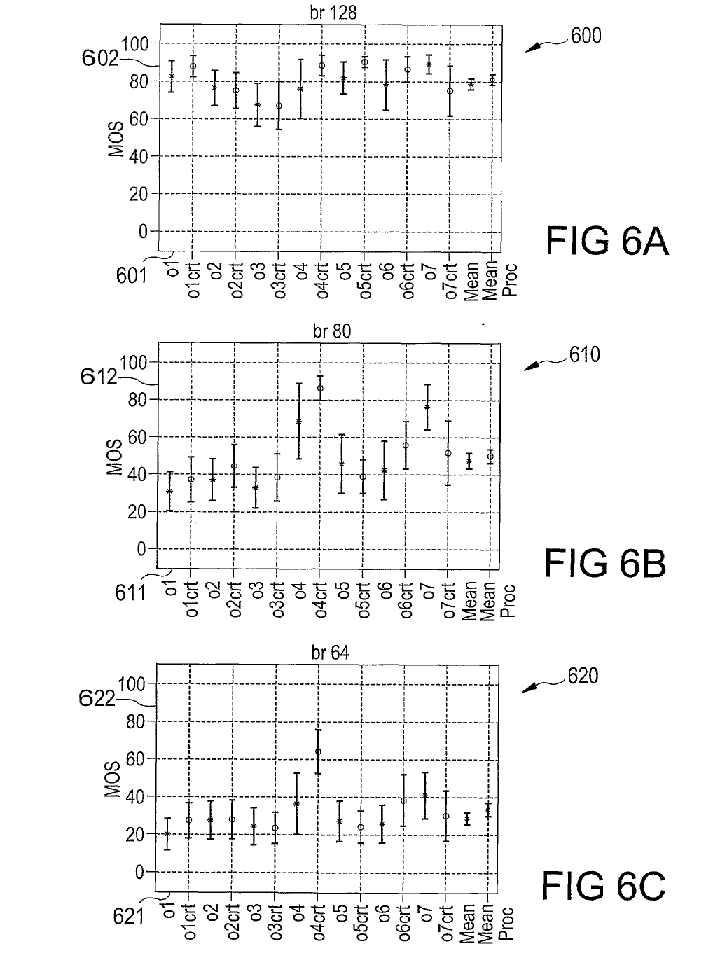

FIG. 6A to FIG. 6C show, for a bit-rate of 128 kb/s (FIG. 6A), of 80 kb/s (FIG. 6B), and of 64 kb/s (FIG. 6C), diagrams 600, 610, 620 having abscissa 601, 611, 621 along which experiments with different excerpts O1-O7 are plotted, with (Oicrt) and without (Oi) cross-talk included, wherein i=1, 2, . . . , 7. Along ordinates 602, 612, 622, the Mean Opinion Scores (MOS) are plotted for the different experiments, respectively.

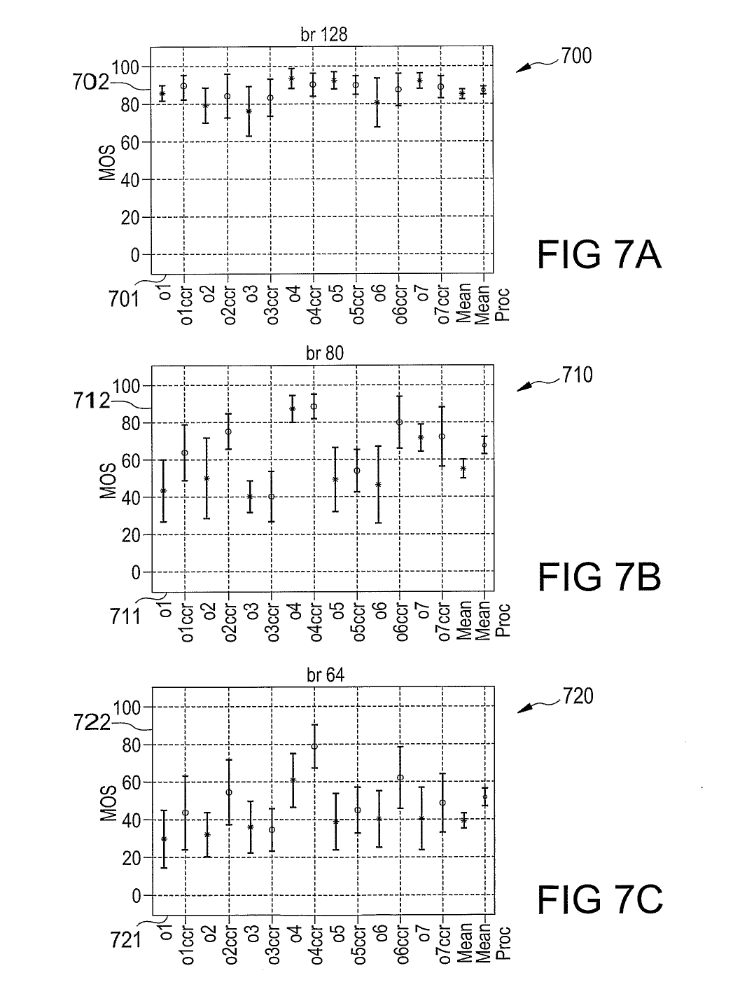

FIG. 7A to FIG. 7C show, for a bit-rate of 128 kb/s (FIG. 7A), of 80 kb/s (FIG. 7B), and of 64 kb/s (FIG. 7C), diagrams 700, 710, 720 having abscissa 701, 711, 721 along which experiments with different excerpts O1-O7 are plotted, with (Oiccr) and without (Oi) reverberation and cross-talk included, wherein i=1, 2, . . . , 7. Along ordinates 702, 712, 722, the Mean Opinion Scores (MOS) are plotted for the different experiments, respectively.

Again referring to FIG. 5A to FIG. 7C, the Mean Opinion Score (MOS) is shown for seven excerpts and for the bit-rates 64 kb/s, 80 kb/s and 128 kb/s. The points indicated with “*” are just the MP3 files at the given bit-rates played back over headphones. The points indicated with “O” are the same, but additionally include reverberation (FIG. 5A to FIG. 5C), cross-talk (FIG. 6A to FIG. 6C), and reverberation and cross-talk (FIG. 7A to FIG. 7C), respectively. “Mean” and “Meanproc” show the improvements averaged over all excerpts with and without reverberation and/or cross-talk.

The hidden reference (not shown) consistently received a high score. This indicates that the subjects were capable of their task. FIG. 5A to FIG. 5C show the results for the reverberation experiments that are obtained from listening test sessions S1 and S2. MOS scores are shown for all excerpts O1-O7 (stars) and the corresponding average ‘Mean’. Also shown are excerpts with reverberation added O1r-O7r (circles) and the corresponding average MOS ‘Meanproc’. For example, the MOS of ‘O1’ is obtained from session ‘S1’ and the MOS of ‘O1r’ is obtained from session ‘S2’ as indicated in FIG. 4.

Thus, FIG. 5A to FIG. 5C show MOS scores for excerpts O1-O7 and the corresponding average MOS ‘Mean’ and excerpts with reverberation added O1r-O7r and the corresponding average MOS ‘Meanproc’.

Results show that quality scores of the reverberated excerpts were about 10 to 20 points higher than for the corresponding ‘dry’ (unfiltered) excerpts for 64 kb/s bit-rates, while these differences become smaller with increasing bit-rate. More artefacts were present in the lower bit-rate encodings, which may explain that the improvement effect of reverberation is higher in these cases. The anchor versions (not shown) were not affected by the presence of reverberation. The results indicate that coding artefacts can become less audible in reverberant listening conditions.

FIG. 6A to FIG. 6C shows the results for the cross-talk experiments that are obtained from listening test sessions S3 and S4 in a similar way as in FIG. 5A to FIG. 5C. From the mean of the scores (‘Mean’, ‘Meanproc’) it can be seen that coding artefacts tend to become less pronounced when cross-talk is applied prior to headphone listening. The improvement of adding cross-talk is less significant than the improvement obtained by adding reverberation, even at lower bit-rates. However, excerpt 4 is improved significantly by adding cross-talk. This solo singing excerpt is an almost mono recording, which contains some stereo reverberation. It is expected that coding artefacts mainly stem from this reverberation, which is averaged by the cross-talk system.

FIG. 7A to FIG. 7C show MOS scores for excerpts O1-O7 and the corresponding average MOS ‘Mean’ and excerpts with cross-talk added O1crt-O7crt and the corresponding average MOS ‘Meanproc’.

In FIG. 7A to FIG. 7C, the results are shown in a similar way as in FIG. 5A to FIG. 5C for the combined cross-talk and reverberation experiments that are obtained from listening test sessions S5 and S6. The improvements are significant, but they seem to be dominated by the improvements obtained from only using reverberation.

The MOS for ‘dry’ excerpts (stars) would be expected to be similar in all figures for the corresponding bit-rates and excerpt numbers because subjects were presented with the same signals in these conditions. The results show, however, that there are differences across the figures, which indicate that subjects changed their rating strategy. This underlines the importance of the balanced experimental design (see FIG. 4) to avoid that the average differences between processed and unprocessed items is affected by this factor.

FIG. 7A to FIG. 7C show MOS scores for excerpts O1-O7 and the corresponding average MOS ‘Mean’ and excerpts with reverberation and cross-talk added O1ccr-O07 ccr and the corresponding average MOS ‘Meanproc’.

Concluding, reverberation and cross-talk have a significant influence in the subjective quality of compressed audio. When reverberation is applied to decoded MP3 files and the corresponding original signals, the MOS increases suggesting that coding artefacts become less pronounced. The experiments have been repeated with excerpts to which cross-talk of a spherical head was added. Similarly, experiments are conducted with both cross-talk and reverberation. Introducing cross-talk has less effect than introducing reverberation These results have implications for the subjective evaluation of audio coding algorithms suggesting that headphone listening is more critical than loudspeaker listening.

In other words, a system of processing audio data comprises a decoding unit and a determining unit having first determining means and second determining means. The decoding unit is adapted to decode encoded audio data to generate decoded audio data. The first determining means are adapted to determine properties of the decoded audio data and/or of reproduction conditions under which the decoded audio data is to be reproduced, and the second determining means are adapted to determine an amount of reverberation and/or of cross-talk to be added to the decoded audio data based on the determined properties of the decoded audio data and/or of the determined reproduction conditions under which the decoded audio data is to be reproduced.

1. A system (100) of processing audio data, comprising:
a decoding unit (102) adapted to decode encoded audio data to generate decoded audio data;
first determining means (102, 105) adapted to determine properties of the decoded audio data and/or of reproduction conditions under which the decoded audio data is to be reproduced;
second determining means (106) adapted to determine on the one hand an amount of reverberation and/or of cross-talk to be added to the decoded audio data based on the determined properties of the decoded audio data and/or on the other hand the determined reproduction conditions under which the decoded audio data is to be reproduced.

2. The system (100) according to claim 1,
wherein the decoding unit (102) comprises a decompression unit adapted to decompress compressed audio data to generate the decoded audio data.

3. The system (100) according to claim 2,
wherein the decompression unit is adapted to decompress compressed audio data having an MP3 format.

4. The system (100) according to claim 1,
wherein the first determining means (102, 105) are adapted such that the properties of the decoded audio data, based on which an amount of reverberation and/or of cross-talk to be added to the decoded audio data is determined, include a quality parameter indicating the quality of the decoded audio data.

5. The system (100) according to claim 4,
wherein the quality parameter is the bit-rate of the audio data.

6. The system (100) according to claim 4,
wherein the quality parameter is derived from the amount and/or the distribution of spectral holes in the audio data.

7. The system (100) according to claim 1,
wherein the first determining means (102) are adapted such that the properties of the decoded audio data, based on which an amount of reverberation and/or of cross-talk to be added to the decoded audio data is determined, include the nature of the decoded audio data.

8. The system (100) according to claim 1,
wherein the first determining means (102, 105) are adapted such that the properties of the decoded audio data, based on which an amount of reverberation and/or of cross-talk to be added to the decoded audio data is determined, include the fact whether a mid-side coding is included in the decoded audio data.

9. The system (100) according to claim 1,
wherein the first determining means (102, 105) are adapted such that the properties of the decoded audio data, based on which an amount of reverberation and/or of cross-talk to be added to the decoded audio data is determined, include an audio bandwidth of the decoded audio data.

10. The system (100) according to claim 1,
wherein the first determining means (102, 105) are adapted such that the properties of the decoded audio data, based on which an amount of reverberation and/or of cross-talk to be added to the decoded audio data is determined, include the fact whether a variable bit-rate is present in the decoded audio data.

11. The system (100) according to claim 1,
wherein the first determining means (102, 105) are adapted such that the properties of the decoded audio data, based on which an amount of reverberation and/or of cross-talk to be added to the decoded audio data is determined, include a time-varying bit stream parameter of the decoded audio data.

12. The system (100) according to claim 1,
wherein the first determining means (102, 105) are adapted such that the reproduction conditions under which the decoded audio data is to be reproduced, based on which an amount of reverberation and/or of cross-talk to be added to the decoded audio data is determined, include the type of reproduction apparatus (214) by which the decoded audio data is to be reproduced.

13. The system (100) according to claim 12,
wherein the first determining means (102, 105) are adapted such that the reproduction conditions under which the decoded audio data is to be reproduced, based on which an amount of reverberation and/or of cross-talk to be added to the decoded audio data is determined, include the fact whether the decoded audio data is to be reproduced by a loudspeaker or by a headphone (214).

14. The system (100) according to claim 1,
wherein the first determining means (102, 105) are adapted such that the reproduction conditions under which the decoded audio data is to be reproduced, based on which an amount of reverberation and/or of cross-talk to be added to the decoded audio data is determined, include the amount of natural reverberation of an environment in which the decoded audio data is to be reproduced.

15. The system (100) according to claim 1,
wherein the second determining means (102, 105) are adapted to determine an amplitude and/or a decay time of reverberation to be added to the decoded audio data.

16. The system (100) according to claim 1,
comprising an adding unit (109) adapted to add the amount of reverberation and/or of cross-talk determined by the second determining means (106) to the decoded audio data to generate output audio data.

17. The system (100) according to claim 16,
comprising a headphone (214) connected to the adding unit (109), the headphone (214) being adapted to generate and emit acoustic waves based on the output audio data.

18. The system (100) according to claim 1,
realized as an integrated circuit.

19. The system (100) according to claim 1,
realized as a portable audio player or as a DVD player or as an MP3 player or as an internet radio device.

20. A method of processing audio data,
comprising the steps of:
decoding encoded audio data to generate decoded audio data;
determining properties of the decoded audio data and/or of reproduction conditions under which the decoded audio data is to be reproduced, and determining on the one hand an amount of reverberation and/or of cross-talk to be added to the decoded audio data based on the determined properties of the decoded audio data and/or on the other hand of the determined reproduction conditions under which the decoded audio data is to be reproduced.

21. The method according to claim 20,
wherein the amount of reverberation and/or of cross-talk to be added to the decoded audio data is determined dynamically.

22. A program element, which, when being executed by a processor, is adapted to carry out a method of processing audio data comprising the steps of:
decoding encoded audio data to generate decoded audio data;
determining properties of the decoded audio data and/or of reproduction conditions under which the decoded audio data is to be reproduced, and determining on the one hand an amount of reverberation and/or of cross-talk to be added to the decoded audio data based on the determined properties of the decoded audio data and/or on the other hand of the determined reproduction conditions under which the decoded audio data is to be reproduced.

23. A computer-readable medium, in which a computer program is stored which, when being executed by a processor, is adapted to carry out a method of processing audio data comprising the steps of:
decoding encoded audio data to generate decoded audio data;
determining properties of the decoded audio data and/or of reproduction conditions under which the decoded audio data is to be reproduced, and determining on the one hand an amount of reverberation and/or of cross-talk to be added to the decoded audio data based on the determined properties of the decoded audio data and/or on the other hand of the determined reproduction conditions under which the decoded audio data is to be reproduced.
